(19) United States
(12) Patent Application Publication
(10) Pub. No.: US 2010/0186407 A1
(43) Pub. Date: Jul. 29, 2010

(54) PARTICLE BURNING IN AN EXHAUST SYSTEM

(76) Inventor: Lincoln Evans-Beauchamp, Palo Alto, CA (US)

Correspondence Address: RONALD ROHDE;Purify Solutions, 2690 Middlefield Road, Unit D&E, Redwood City, CA, 94063, US

(21) Appl. No.: 12/753,630

(22) Filed: Apr. 2, 2010

Related U.S. Application Data
(63) Continuation-in-part of application No. 11/404,424, filed on Apr. 14, 2006.

(51) Int. Cl. F02B 37/20; F01N 3/00; B01D 53/92

(52) U.S. Cl. 60/605.1; 422/173; 204/157.3

(57) ABSTRACT

An exhaust system includes a combustion chamber and a radiation source configured to heat particles in an exhaust stream as the stream passes through the chamber. Once the particles are brought to an ignition temperature and begin to burn, the reaction within the chamber can become self-sustaining. The radiation source can comprise a resistive heating element, an infrared emitter, or a microwave emitter. The radiation source may radiate into the chamber through a radiation transparent window. The chamber may have a cross-section perpendicular to a longitudinal axis that is parabolic or partially parabolic. The exhaust system can also comprise a heat exchanger to pre-heat the exhaust before entering the chamber. Embodiments of the system can be configured to additionally perform as a catalytic converter and/or a muffler. A fuel such as urea or ammonia may be used in the heat exchanger for converting oxides of nitrogen. The exhaust system may be disposed between an engine and a turbocharger.

### CROSS-REFERENCE TO RELATED APPLICATIONS

The present application is a continuation in part and claims the priority and benefit of U.S. patent application Ser. No. 11/404,424 titled “PARTICLE BURNING IN AN EXHAUST SYSTEM,” filed Apr. 14, 2006. The disclosure of the above U.S. patent application is incorporated by reference herein in its entirety.

### BACKGROUND OF THE INVENTION

1. Field of the Invention

The present invention is related generally to emission controls and more particularly to systems for reducing particles in exhaust streams.

2. Description of the Prior Art

When a fuel burns incompletely, pollutants such as particles and hydrocarbons are released into the atmosphere. The United States Environmental Protection Agency has passed regulations that limit the amount of pollutants that, for example, diesel trucks, power plants, engines, automobiles, and off-road vehicles can release into the atmosphere.

Currently, industries attempt to follow these regulations by adding scrubbers, catalytic converters and particle traps to their exhaust systems. However, these solutions increase the amount of back pressure exerted on the engine or combustion system, decreasing performance. In addition, the scrubbers and particle traps themselves become clogged and require periodic cleaning to minimize back pressure.

Radiation sources and heaters have been used in exhaust systems, for example, to periodically clean the particle traps or filter beds. Others solutions have included injecting fuel into the filter beds or exhaust streams as the exhaust enters the filter beds to combust the particles therein. However, the filter beds can be sensitive to high temperatures and the radiation sources and heaters must be turned off periodically.

### SUMMARY

An exhaust system comprises a combustion chamber and a radiation source. The radiation source is arranged with respect to the combustion chamber, either inside or outside of the chamber, so as to be able to produce radiation within the combustion chamber. The radiation source can comprise a resistive heating element, a coherent or incoherent infrared emitter, or a microwave emitter, for example. The microwave emitter can be tuned to a particular molecular bond. Where the radiation source is disposed outside of the combustion chamber, the radiation source can either heat the chamber walls to reradiate into the chamber, else the combustion chamber can include a radiation transparent window.

Particles in an exhaust stream passing through the combustion chamber are heated by the radiation to an ignition point and are consequently removed from the exhaust by burning. Microwave radiation tuned to excite a molecular bond found in the particles can be particularly effective for heating the particles rapidly. Additional air or fuel can be added to the combustion chamber, as needed, to promote better combustion. Once a flame front is established in the combustion chamber, the combustion reaction can become self-sustaining so that further radiation from the radiation source is no longer required.

In some embodiments, the combustion chamber has a non-circular cross-section perpendicular to a longitudinal axis of the chamber. In some of these embodiments, the cross-section is at least partially parabolic to focus heat from the burning particles back into a hot zone within the combustion chamber where the particle burning preferentially occurs. The combustion chamber can be thermally insulated to better retain heat in order to maintain the combustion reaction. The exhaust system can also comprise a thermally insulated exhaust pipe leading to the combustion chamber to further reduce the loss of heat from the exhaust stream before particle burning can occur. In some embodiments, a reverse flow heat exchanger is placed in fluid communication with the combustion chamber so that heat is transferred to the incoming exhaust stream from the combusted exhaust stream exiting the combustion chamber. In certain embodiments, the reverse flow heat exchanger is also thermally insulated.

One advantage of certain embodiments of the present invention is the absence of a particle filter or trap within the combustion chamber. While prior art systems have attempted to trap particles and then periodically clean the trap or filter, these systems create significant back-pressure as such traps and filters obstruct the exhaust flow, especially as they become plugged with particles. Continuously burning the particles in the combustion chamber without the use of such traps or filters provides a more simple design that additionally reduces back-pressure.

A vehicle comprising an internal combustion engine and the exhaust system described above is also provided. The exhaust system can serve as either or both of a muffler and a catalytic converter. Thus, the combustion chamber can also include a catalyst. In some embodiments, the combustion chamber and/or the reverse flow heat exchanger can be sized to act as a resonating chamber to serve as a muffler. For example, the combustion chamber can have a diameter greater than a diameter of the exhaust pipe leading into the combustion chamber. The vehicle can also comprise a controller configured to control the radiation source.

The system described herein can be implemented in a variety of settings where particles are present in a gas stream. Some embodiments include automobile exhaust systems, diesel exhaust systems, power plant emission systems, fireplace chimneys, off-road vehicle exhaust systems, and the like.

### BRIEF DESCRIPTION OF THE FIGURES

FIG. 1 depicts a system for burning particles in an exhaust system in accordance with one embodiment of the invention.

FIG. 2 depicts another embodiment of the system of FIG. 1 for burning particles in an exhaust system, in accordance with aspects the invention.

FIG. 3 depicts a system for burning particles in an exhaust system in accordance with another embodiment of the invention.

FIG. 4 depicts a system for burning particles in an exhaust system in accordance with another embodiment of the invention.

FIG. 5 depicts a cross sectional view of the system for burning particles of FIG. 1, 2, 3, or 4 further comprising a reverse flow heat exchanger.

FIG. 6 depicts a schematic representation of a vehicle comprising an internal combustion engine and the exhaust system of FIG. 1, 2, 3, 4, or 5.

FIG. 7 depicts an embodiment of a selective catalytic reduction exhaust system.

FIG. 8 depicts a schematic representation of an alternative embodiment of the vehicle of FIG. 6 comprising an internal combustion engine a turbo charger and the exhaust system of FIG. 1, 2, 3, 4, 5 or 7.

### DETAILED DESCRIPTION

An exhaust system comprises a combustion chamber and a radiation source to facilitate the combustion of particles within the chamber. Once ignited, the combustion can continue so long as the concentration of particles in the exhaust entering the chamber remains sufficiently high. The disclosed device can replace both the muffler and the catalytic converter in a vehicle exhaust system and offers reduced back pressure for better fuel economy and lower maintenance costs. The device requires little to no maintenance and is self-cleaning.

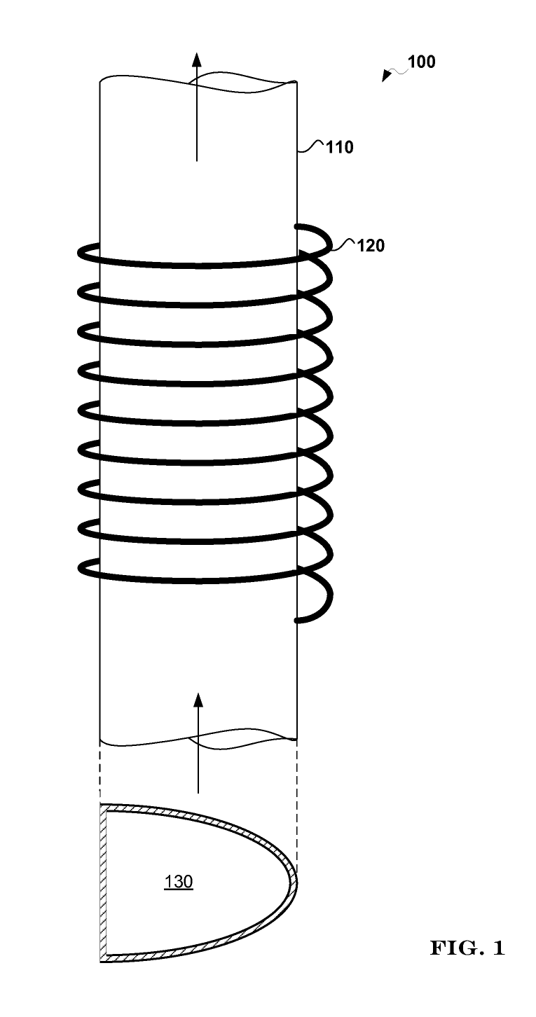

FIG. 1 depicts an exhaust system 100 comprising a combustion chamber 110 and a radiation source 120. The combustion chamber 110 can be constructed using any suitable material capable of withstanding the exhaust gases at the combustion temperature of the particles. Suitable materials include stainless steel, titanium, and ceramics. In one embodiment, the combustion chamber 110 has a non-circular cross-section 130 perpendicular to a longitudinal axis of the combustion chamber 110. At least a portion of the cross-section 130 can be parabolic in order to focus radiation from the combustion reaction into a hot zone within the combustion chamber 110. It will be appreciated that the combustion chamber 110, in some embodiments, can be proportioned to serve as a resonating chamber so that the combustion chamber 110 also performs as a muffler.

One advantage of certain embodiments of the present invention is the absence of an obstructing particle filter or trap within the combustion chamber 110. A particle trap or filter is obstructing if it would at least partially restrict the flow of an exhaust gas through the combustion chamber 110. By not restricting the flow of exhaust gas through the combustion chamber 110, embodiments of the invention serve to reduce back-pressure compared with prior art systems.

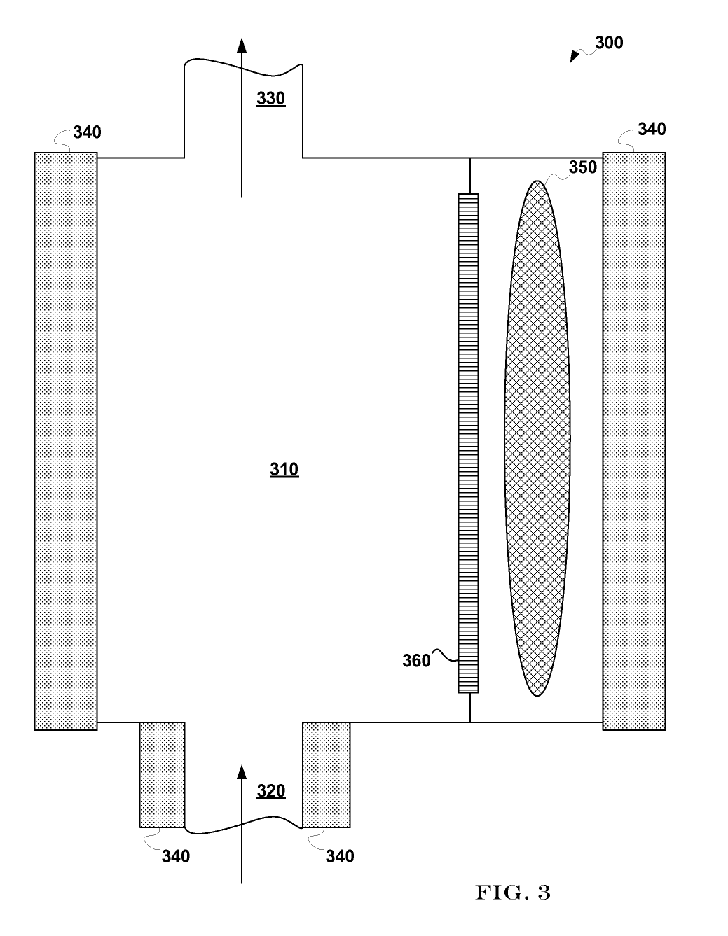

Radiation source 120, in the illustrated embodiment, comprises a resistive heating element wrapped around the outside of the combustion chamber 110. In another embodiment, the radiation source 120 is placed externally along the longitudinal length of the combustion chamber 110. In some embodiments, a controller (shown elsewhere herein) for the radiation source 120 is provided to control the power to the radiation source 120 and to turn off the radiation source 120 when not needed, such as when no exhaust is flowing or when a combustion reaction is self sustaining within the combustion chamber 110. Alternative radiation sources are discussed below with reference to FIG. 3.

In operation, an exhaust gas containing particles, such as carbonaceous particles like soot, flows through the combustion chamber 110. The radiation source 120 heats the wall of the combustion chamber 110 which re-radiates infrared (IR) radiation into the interior of the combustion chamber 110. Some of the IR radiation is absorbed by the particles in the exhaust gas as they traverse the combustion chamber 110. When the particles reach a temperature at which they ignite, about 800° C. for carbonaceous particles, the particles burn completely, leaving no residue. Accordingly, essentially particle-free exhaust leaves the combustion chamber 110.

The heat produced by the combustion of the particles can make the continuing reaction self-sustaining so that the radiation source 120 is not necessary. A thermocouple (shown elsewhere herein) can be placed on or in the combustion chamber 110 in order to monitor the temperature of the combustion reaction to provide feedback to a controller (shown elsewhere herein) for controlling the power to the radiation source 120. As noted above, the combustion chamber 110 can be shaped to focus IR radiation from the combustion reaction onto a focal point or line within the combustion chamber 110 to create a hot zone that helps to sustain the continuing reaction in the absence of external heating.

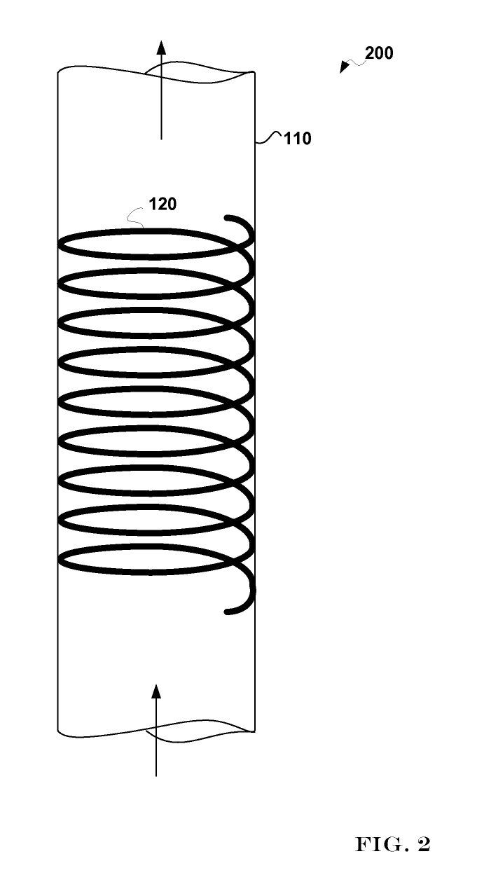

FIG. 2 depicts an exhaust system 200 comprising the combustion chamber 110 and a radiation source 120. In exhaust system 200, the radiation source 120 is disposed within the combustion chamber 110. The radiation source 120, as shown, comprises a coiled resistive heating element. As above, the radiation source 120 can take other shapes and, for example, can be longitudinally disposed internally along the length of the combustion chamber 110. In those embodiments in which the radiation source 120 is disposed within the combustion chamber 110, radiation from the radiation source 120 can directly heat the particles in the exhaust as well as heat the walls of the combustion chamber 110 as in the embodiment of FIG. 1. While the direct heating of the particles is more energy efficient, placing the radiation source 120 within the combustion chamber 110 disadvantageously exposes the radiation source 120 to the high-temperature exhaust gases. As above, the combustion chamber 110 of FIG. 2 can have a non-circular cross-section.

FIG. 3 depicts an exhaust system 300 comprising a combustion chamber 310 having an inlet 320 and an outlet 330, optional thermal insulation 340, a radiation source 350, and a radiation transparent window 360 into the combustion chamber 310. In the illustrated embodiment, a diameter of the combustion chamber 310 is greater than a diameter of the inlet 320. This arrangement slows the exhaust gas as it enters the combustion chamber 310 and can create a muffling effect. As above, the combustion chamber 310 can have a non-circular cross-section.

In some embodiments, the inlet 320 and/or the combustion chamber 310 are thermally insulated by the thermal insulation 340 to retain as much heat as possible in the exhaust gas as the gas enters the combustion chamber 310. It will be appreciated that insulation 340 can be similarly applied to the other embodiments disclosed herein. For example, a blanket of insulation 340 can be wrapped around the radiation source 120 and combustion chamber 110 of FIG. 1.

Radiation source 350 can be, for example, a coherent or incoherent IR emitter or microwave emitter, such as a Klystron tube. Unlike a resistive heating element, radiation source 350 can be configured to emit radiation directionally and/or within a desired range of wavelengths. Accordingly, radiation transparent window 360 is provided to allow radiation to pass directly into the combustion chamber 310. In some embodiments, the radiation transparent window 360 extends completely around the circumference of the combustion chamber 310.

As noted, radiation source 350 can be tuned to produce radiation within a desired range of wavelengths. Thus, the radiation can be tuned to excite specific molecular bonds that are known to be present in the particles of the exhaust stream. For example, microwave radiation can be tuned to excite carbon-hydrogen bonds or carbon-carbon bonds where the particles in the exhaust are known to include such bonds. Tuning the radiation in this manner can heat particles to their ignition temperature more quickly and with less energy.

The radiation transparent window 360 is constructed using a material that can withstand the heated exhaust gases within the combustion chamber 310. In some embodiments, radiation transparent window 360 is a microwave transparent window constructed using fiberglass, plastic, polycarbonate, quartz, porcelain, or the like. In other embodiments, the radiation transparent window 360 is an IR transparent window constructed using, for instance, sapphire.

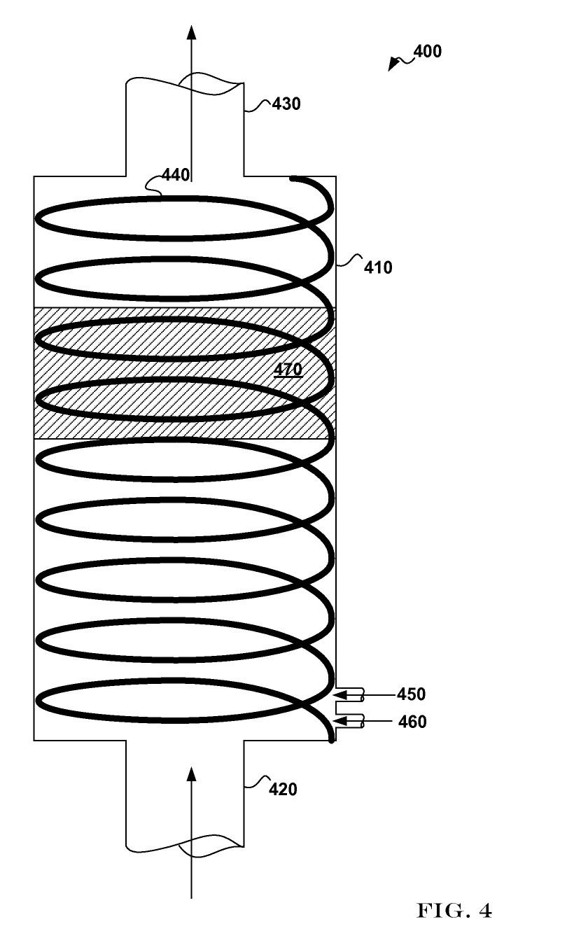

FIG. 4 depicts an exhaust system 400 to illustrate other optional components that can be employed in conjunction with any of the preceding embodiments (i.e., exhaust system 100, 200, or 300). Exhaust system 400 comprises a combustion chamber 410 having an inlet 420 and an outlet 430, a radiation source 440, an air inlet 450, a fuel inlet 460, and a catalyst 470. As illustrated in the previous example of exhaust system 300, the combustion chamber 410 can have a greater diameter than the inlet 420 and the outlet 430. Alternatively, the outlet 430 can have the same diameter as combustion chamber 410, as illustrated in the examples of exhaust system 100 and 200. The combustion chamber 410 can have a non-circular cross-section, as illustrated in the exhaust systems 100, 200, or 300. The radiation source 440, as shown, is a resistive heating element disposed within the combustion chamber 410, but can alternatively be disposed externally and can alternatively be an IR or microwave emitter.

The combustion chamber 410 may comprise air intake 450 and/or fuel intake 460. In some embodiments, air intake 450 is configured to introduce oxygen to the combustion chamber to aid the combustion reaction in the event that there is not enough oxygen present in the exhaust as it enters the combustion chamber 410. In other embodiments, fuel intake 460 introduces fuel into the combustion chamber to burn and, thus, heat the exhaust as it enters through inlet 420. It will be appreciated that adding fuel with or without air can, in some instances, replace the need for a radiation source. In such embodiments, a spark generator or other ignition source can be employed to ignite the combustion reaction with the added fuel.

In certain embodiments, the combustion chamber 410 additionally comprises at least one catalyst 470 to catalyze oxidation and/or reduction reactions in the exhaust stream. The catalyst 470 can include platinum, rhodium, and/or palladium deposited on a honeycomb substrate or ceramic beads. In these embodiments, the combustion chamber 410 is configured to additionally function as a catalytic converter in the exhaust system 400. It will be understood that heating the exhaust gas in the presence of the catalyst 470 can advantageously improve the completeness of the reaction being catalyzed.

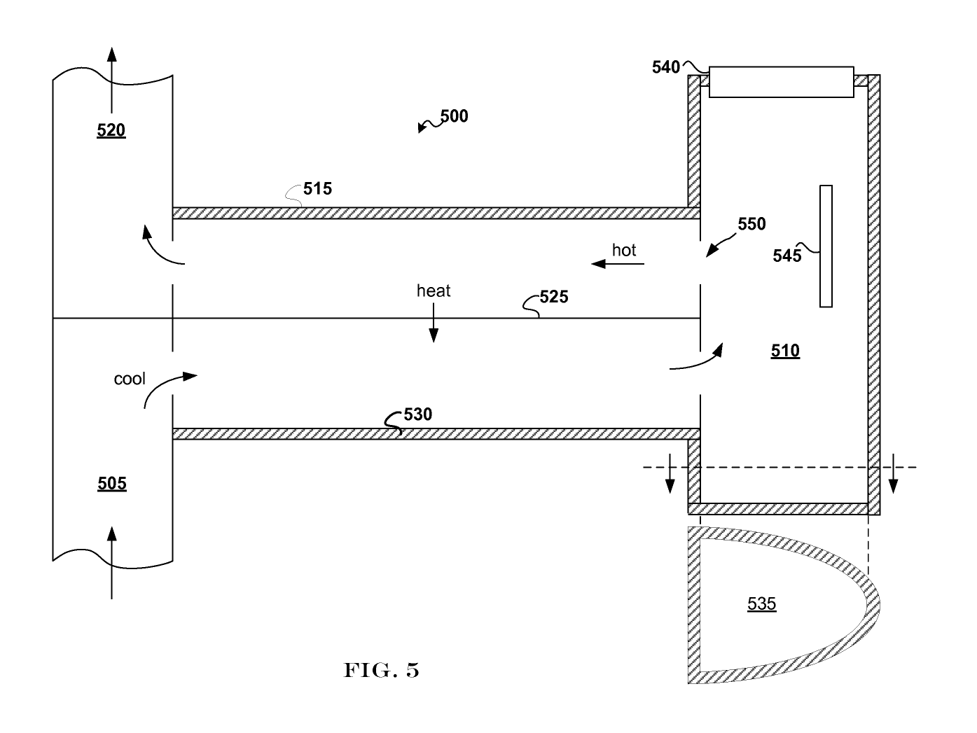

FIG. 5 depicts an exhaust system 500 comprising an inlet 505, a heat exchanger 515, a combustion chamber 510, and an outlet 520. The heat exchanger 515 serves to pre-heat the exhaust before the exhaust enters the combustion chamber 510. The heat exchanger 515 can also serve as a muffler, in some embodiments. Heat exchanger 515 is separated into two or more sections by at least one wall 525. Exhaust enters the exhaust system 500 via the inlet 505 and is directed into one section of the heat exchanger 515. Heated gases exiting the combustion chamber 510 through another section of the heat exchanger 515 transfer heat to the incoming gases through the wall 525. In some embodiments, the heat exchanger 515 and/or the combustion chamber 510 are insulated by thermal insulation 530. As in other embodiments described herein, the inlet 505 can also be thermally insulated.

In some embodiments, the combustion chamber 510 has a parabolic or partially parabolic cross-section 535 perpendicular to a longitudinal axis to create a hot zone. The combustion chamber 510 also comprises a radiation source 540. In some embodiments, the radiation source 540 is a microwave emitter, such as a Klystron tube. Alternatively, radiation source 540 is an IR emitter. In some embodiments, a radiation transparent window separates the radiation source 540 from the combustion chamber 510.

In some embodiments, the combustion chamber 510 further comprises at least one catalyst 545 configured to catalyze oxidation and/or reduction reactions of undesirable gases in the exhaust stream such as NO compounds. In those embodiments where the heat exchanger 515 is configured to act as a muffler, and the combustion chamber 510 comprises catalyst 545, it will be appreciated that the exhaust system 500 can replace both the muffler and the catalytic converter in a conventional vehicle exhaust system. Advantageously, because the combustion chamber 510 burns the particles present in the exhaust stream, it will be further appreciated that the exhaust system 500 can additionally replace a particle trap in a conventional vehicle exhaust system. One of skill in the art will also recognize that the exhaust systems disclosed herein can also be applied to clean exhaust streams from non-vehicular sources such as power plants, fireplace chimneys, industrial and commercial processing, and the like.

It should be noted that in some embodiments the catalyst 545 comprises a substrate, such as a grating, with a surface coating of a catalytic material that is placed over an opening 550 of the heat exchanger 515. While such a catalyst 545 may at least partially restrict the flow of exhaust gas through the combustion chamber 510, the catalyst is not a particle trap or filter. Specifically, openings in the grating are too large to trap or filter the particles in the exhaust entering the combustion chamber 510. Additionally, such a catalyst 545 cannot collect particles for two reasons. First, particles are eliminated from the exhaust before the exhaust reaches the opening 550. Second, even if a particle survives the combustion reaction and adheres to the catalyst 545, the restriction around the particle would cause a local increase in temperature which would cause the particle to burn and not be retained thereon.

Likewise, some embodiments that employ a microwave emitter as the radiation source 540 include a microwave-blocking grating (not shown) either across the opening 550 or further downstream along the exhaust path to prevent microwaves from propagating out of the exhaust system 500. For essentially the reasons discussed above, although such a microwave-blocking grating may at least partially restrict the flow of exhaust gas through the combustion chamber 510, the microwave-blocking grating is not a particle trap or filter. The openings of the grating are too large to trap or filter particles in the exhaust, particles are eliminated from the exhaust before the exhaust reaches the microwave-blocking grating, and any particles that survive and adhere to the microwave-blocking grating simply burn off. While the exhaust system 500 illustrated in FIG. 5 includes the combustion chamber 510, the exhaust system 500 alternatively includes the combustion chamber 110, 310, or 410, which are described elsewhere herein.

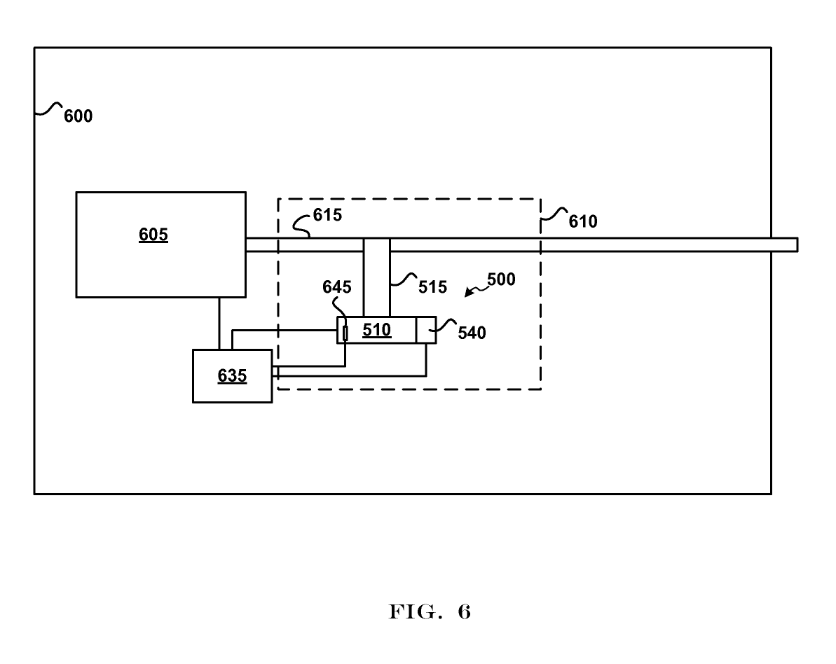

FIG. 6 shows a schematic representation of a vehicle 600 comprising an internal combustion engine 605 such as a diesel engine. The vehicle 600 also comprises an exhaust system 610 that includes the exhaust system 500 of FIG. 5 including the reverse flow heat exchanger 515, the combustion chamber 510, and the radiation source 540. As in previous examples, the combustion chamber 510 may include a catalyst 545. The exhaust system 610 further includes a thermocouple 645 and an exhaust pipe 615 from the engine 605 to the reverse flow heat exchanger 515. The vehicle 600 further comprises a controller 635 for controlling the power to the radiation source 540. The controller 635 can be coupled to the engine 605 so that no power goes to the radiation source 540 when the engine is not operating, for example. The controller 635 can also control the radiation source 540 in a manner that is responsive to engine 605 operating conditions. Further, the controller 635 can also control the radiation source 540 according to conditions in the combustion chamber 510. For instance, the controller 635 can monitor the thermocouple 645 in the combustion chamber 510 so that no power goes to the radiation source 540 when the temperature within the combustion chamber 510 is sufficiently high to maintain a self-sustaining combustion reaction. While the vehicle 600 illustrated in FIG. 6 includes the exhaust system 500, the vehicle 600 alternatively includes the exhaust system 100, 200, 300, or 400 instead of the exhaust system 500.

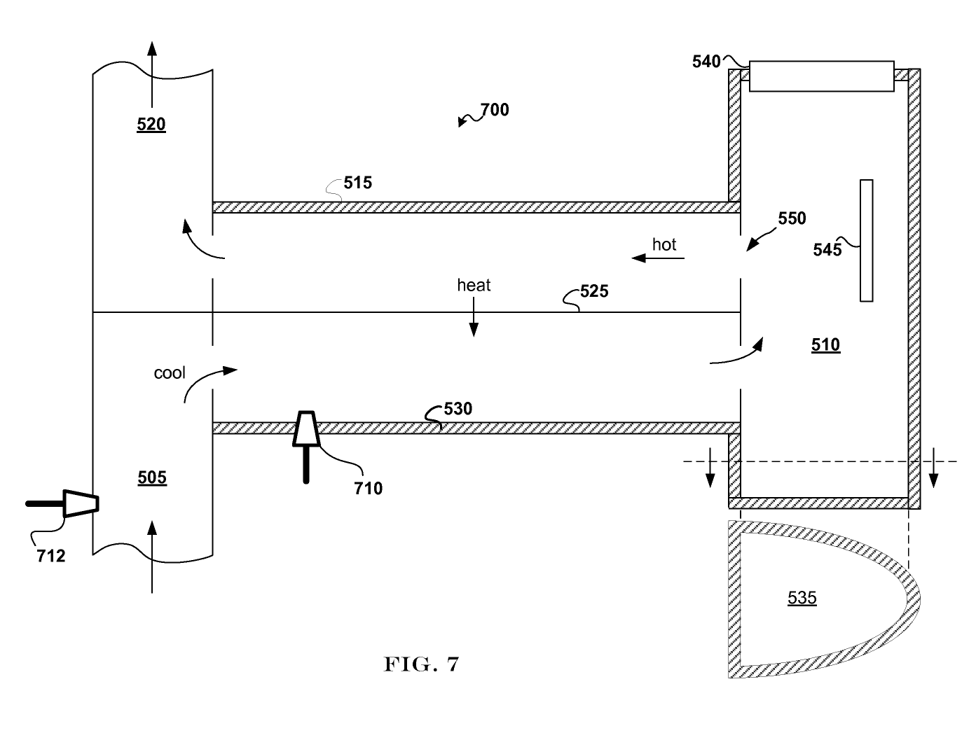

FIG. 7 illustrates an embodiment of a selective catalytic reduction (SCR) exhaust system 700. The exhaust system 700 differs from the exhaust system 500 of FIG. 5 in that the exhaust system 700 includes SCR injector 710 and/or SCR injector 712. SCR is a method for injecting a fuel such as ammonia or urea into an exhaust stream to promote a reduction reaction of oxides of nitrogen (NOx) to nitrogen and oxygen. The reduction of NOx using the fuel may be promoted using the catalyst 545. That is, the ammonia or urea may be used to enhance the action of the catalyst 545 in the combustion chamber 510. While the fuel such as ammonia or urea may be introduced directly into the combustion chamber as illustrated in FIG. 4 at fuel inlet 460, the exhaust system 700 illustrates introducing the fuel into the exhaust up stream of the combustion chamber.

The SCR injector 710 is configured to inject the fuel into the heat exchanger 515. The fuel may be vaporized before injection or the SCR injector 710 may mist or vaporize during injection into the heat exchanger 515. The SCR injector 710 may be used for mixing the fuel and the exhaust. For example, the injector 710 may inject the fuel counter to the flow of the exhaust. Counter flow injection further increases time for mixing action. The heat exchanger 515 may be configured for mixing the exhaust and the injected fuel from the SCR injector 710. For example, turbulence and/or wave action of exhaust due to geometry, texture, and/or heat flow within the heat exchanger 515 may enhance mixing of the fuel and exhaust. Alternatively, the SCR injector 710 is configured to inject the fuel in a direction parallel to the flow of exhaust. Parallel flow injection may enhance the flow of exhaust, thus, providing a exhaust pumping action. A plurality of SCR injectors 710 may be disposed in the heat exchanger 515, including at least one configured for counter flow fuel injection, and at least one configured for parallel flow injection.

The SCR injector 712 is configured to inject fuel into the inlet 505 in a similar manner to the SCR injector 710. A plurality of SCR injectors 712 may be disposed in the inlet 505 including at least one configured for counter flow fuel injection, and at least one configured for parallel flow injection.

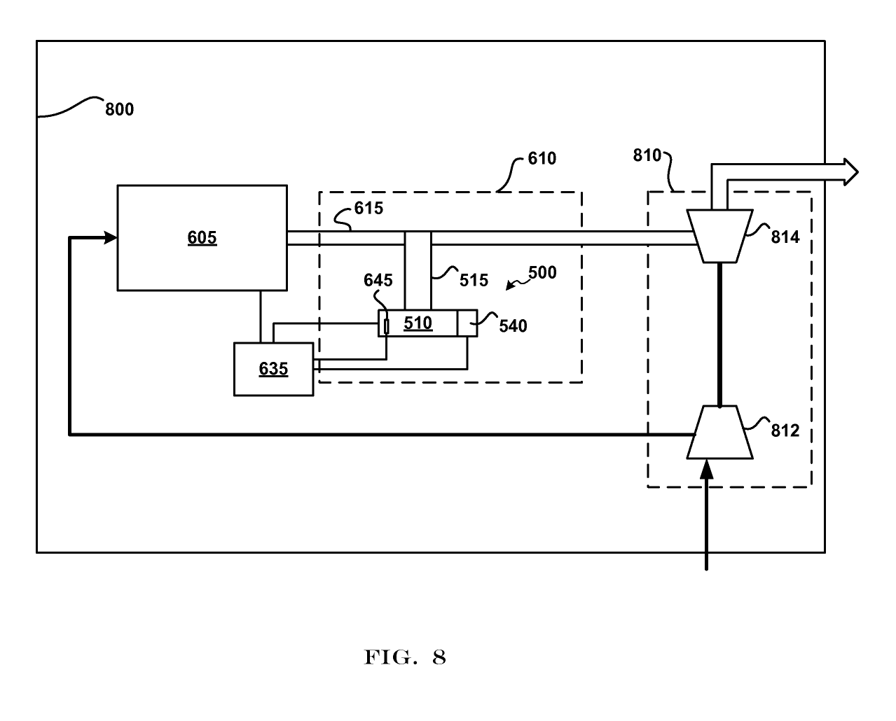

FIG. 8 depicts a schematic representation of an alternative embodiment of a vehicle 800. The vehicle 800 of FIG. 8 differs from vehicle 600 in that the vehicle includes a turbo charger 810. The exhaust system 610 is disposed between the engine 605 and the turbo charger 810. In various embodiments, the exhaust system 610 includes the exhaust system 100 of FIG. 1 or 2, the exhaust system 300 of FIG. 3, the exhaust system 300 of FIG. 4, the exhaust system 300 of FIG. 5, and/or the exhaust system 300 of FIG. 7. The turbo charger 810 includes a compressor 812 coupled to a turbine 814. The compressor 812 is configured to compress air for combustion in the engine 605. The turbine 814 is configured to receive exhaust via the exhaust system 610 and use the exhaust for driving the compressor 812.

In the foregoing specification, the present invention is described with reference to specific embodiments thereof, but those skilled in the art will recognize that the present invention is not limited thereto. Various features and aspects of the above-described present invention may be used individually or jointly. Features in each of the various illustrations may be combined with features in other illustrations or used individually for illustrating the present invention. Further, the present invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. An exhaust system comprising:
a combustion chamber including a longitudinal axis and having a non-circular cross-section, the cross-section of the chamber being perpendicular to the longitudinal axis;
a reverse flow heat exchanger in fluid communication with the combustion chamber;
a radiation source external to the combustion chamber and positioned to transmit radiation into the combustion chamber, the radiation configured to heat exhaust gas within the combustion chamber; and
a window transparent to a wavelength of the radiation for passing the radiation from the radiation source into the combustion chamber.

2. The exhaust system of claim 1, wherein the radiation source transmits the radiation directionally into the combustion chamber.

3. The exhaust system of claim 1, wherein the radiation source can be tuned to a wavelength configured to excite a molecular bond of exhaust within the combustion chamber.

4. The exhaust system of claim 1, wherein the radiation source comprises an infrared emitter and the window is transparent to an infrared wavelength.

5. The exhaust system of claim 1, wherein the radiation source comprises a microwave emitter.

6. The exhaust system of claim 5, wherein the microwave transmitter is tuned to excite a molecular bond of a particle within the combustion chamber.

7. The exhaust system of claim 5, wherein the radiation source comprises a Klystron tube.

8. The exhaust system of claim 1, wherein the radiation is coherent.

9. The exhaust system of claim 1, wherein the radiation is tuned to excite carbon-hydrogen bonds or carbon-carbon bonds.

10. The exhaust system of claim 1, wherein the non-circular cross-section of the combustion chamber focuses radiation into a hot zone in the combustion chamber.

11. The exhaust system of claim 10, wherein the non-circular cross-section is at least partially parabolic.

12. The exhaust system of claim 1, wherein the window extends around the combustion chamber.

13. The exhaust system of claim 1, further comprising a grating configured to block the radiation in the combustion chamber.

14. The exhaust system of claim 1, further comprising an engine and a turbo-charger, the exhaust system disposed between the engine and the turbo-charger.

15. A method for removing particles from exhaust gas, the method comprising:
receiving the exhaust gas into a combustion chamber from an engine via a reverse flow heat exchanger;
emitting radiation into the combustion chamber, the emitted radiation directed toward particles in the exhaust gas;
heating the particles to an ignition temperature of the particles using the emitted radiation to initiate combustion of the particles;
increasing power of the radiation when the temperature of the particles is less than an ignition temperature of the particles;
decreasing power of the radiation when the temperature of the exhaust gas is high enough to sustain combustion of the particles;
expelling the exhaust gas from the combustion chamber via the reverse flow heat exchanger; and
exchanging heat between the received exhaust gas and the expelled exhaust gas in the reverse flow heat exchanger.

16. The method of claim 15, further comprising focusing the radiation into a hot-zone within the combustion chamber.

17. The method of claim 15, further comprising tuning a wavelength of the radiation source to excite a molecular bond of the particles.

18. The method of claim 15, further comprising directing the emission of the radiation from outside the combustion chamber toward the particles within the combustion chamber.

19. The method of claim 15, further comprising blocking the radiation in the combustion chamber using a grating.

20. The method of claim 15, wherein the emitted radiation is coherent.

21. The method of claim 15, wherein the radiation is emitted from a radiation source outside the combustion chamber.

22. The method of claim 15, wherein a wavelength of the emitted radiation is in the microwave band.

23. The method of claim 15, further comprising compressing air in a turbo charger for the engine using the expelled exhaust gas from the reverse flow heat exchanger.

24. A muffler comprising:
a combustion chamber configured to burn particles in exhaust gas;
a resonating chamber in fluid communication with an engine and the combustion chamber, the resonating chamber comprising a heat exchanger configured to transfer heat from exhaust gas received from the combustion chamber to exhaust gas received from the engine; and
a radiation source arranged with respect to the combustion chamber so as to direct radiation into the resonating chamber for heating the exhaust gas to an ignition temperature of the particles.

25. The muffler of claim 24, wherein the resonating chamber further comprises a fuel inlet.

26. The muffler of claim 24, wherein the radiation source comprises a Klystron tube and the combustion chamber includes a microwave transparent window disposed such that radiation from the Klystron tube can pass therethrough.

27. The muffler of claim 24, wherein the radiation is tuned to excite bonds in urea or ammonia molecules.

28. The muffler system of claim 24, further comprising a turbo-charger, the muffler disposed between the engine and the turbo-charger.
